(19) United States
(12) Patent Application Publication
(10) Pub. No.: US 2010/0304269 A1
(43) Pub. Date: Dec. 2, 2010

(54) Electrode For Fuel Cell And Method Of Preparing The Same And Membrane Electrode Assembly And Fuel Cell Comprising The Same

(75) Inventors: Hyuk Kim, Daejeon (KR); Won-Ho Lee, Daejeon (KR); Chang-Song Lee, Seoul (KR); Seong-Uk Jeong, Seoul (KR); Sang-Hyun Lee, Namyangiu-si (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 12/682,192

(22) PCT Filed: Oct. 6, 2008
(86) PCT No.: PCT/KR08/05851

§ 371 Date: Aug. 13, 2010

(30) Foreign Application Priority Data
Oct. 10, 2007 (KR) 10-2007-0102054

(51) Int. Cl. H01M 8/10; H01M 8/02; H01M 4/88

(52) U.S. Cl. 429/483; 429/514; 502/101

(57) ABSTRACT

The present invention relates to an electrode for a fuel cell including a catalyst layer that includes a catalyst portion containing a plurality of first catalyst particles dispersed in an ionomer binder resin; and an ionomer portion containing a plurality of second catalyst particles dispersed in an ionomer binder resin, and having a lower concentration of catalyst particles than the catalyst portion, wherein the ionomer portion has a shape of a wall or plural pillars in the catalyst portion. The electrode for a fuel cell according to the present invention has a separate ionomer portion in the catalyst layer, and thus has excellent ion conductivity in an electrode layer and the remarkably improved reaction surface area to enhance the performance of the fuel cell.

### TECHNICAL FIELD

The present invention relates to an electrode for a fuel cell, a method of preparing the same, and a membrane electrode assembly and a fuel cell comprising the same, and in particular, to an electrode for a fuel cell having improved ion conductivity, reaction surface area and durability, a method of preparing the same, and a membrane electrode assembly and a fuel cell comprising the same.

### BACKGROUND ART

Recently, as depletion of conventional energy resources such as oil or coal is foreseen, interest in an alternative energy is increasing. A fuel cell is one of the alternative energy, and advantageously has a high efficiency, does not emit pollutants of NO_{X} and SO_{X} and uses a fuel that is abundant in quantity, and therefore, the fuel cell attracts public attention.

The fuel cell is a power generation system that converts chemical energy of a fuel and an oxidant to electrical energy, and typically hydrogen and hydrocarbon, for example methanol or butane is used as a fuel, and oxygen is used as an oxidant.

In the fuel cell, a membrane electrode assembly (MEA) is the basic unit for generating electricity, and includes an electrolyte membrane and anode and cathode electrodes formed at opposite sides of the electrolyte membrane. FIG. 1 illustrates the principle for generating electricity of a fuel cell, and Chemical FIG. 1 represents a reaction formula of a fuel cell in the case that hydrogen is used as a fuel. Referring to FIG. 1 and Chemical FIG. 1, an oxidation reaction of a fuel occurs at an anode electrode to generate hydrogen ions and electrons, and the hydrogen ions move to a cathode electrode through an electrolyte membrane. The hydrogen ions transmitted through the electrolyte membrane and the electrons react with oxygen (oxidant) at the cathode electrode to generate water. This reaction causes the electrons to move to an external circuit.

Anode electrode: H₂→2H⁺+2e⁻

cathode electrode: ½O₂+2H⁺+2e⁻→H₂O

Reaction formula: H₂+½O₂→H₂O [Chemistry FIG. 1]

FIG. 2 illustrates a general configuration of a membrane electrode assembly for a fuel cell. Referring to FIG. 2, a membrane electrode assembly for a fuel cell includes an electrolyte membrane, and an anode electrode and a cathode electrode located at the opposite sides of the electrolyte membrane. The anode and cathode electrodes each includes a catalyst layer and a gas diffusion layer. The gas diffusion layer includes an electrode substrate and a microporous layer formed on the electrode substrate.

A catalyst layer of a conventional fuel cell membrane electrode assembly is coated with one kind of ink including a catalyst and an ionomer to form an electrode layer that is the same in the XY direction. The electrolyte membrane is contacted with the electrode layer in a plane-to-plane relationship, and a reaction occurs to an interface between the electrolyte membrane and the electrode layer to generate a potential difference. Therefore, it is important to increase a reaction surface area between the electrolyte membrane and the electrode layer so as to improve the performance of a fuel cell.

Conventionally, attempt was made to undulate the surface of the electrolyte membrane so as to increase a reaction surface area between the electrolyte membrane and the electrode layer and improve bondability of the electrode layer. However, this may cause stress on the electrolyte membrane, needs a difficult process and results in failed connection of the entire electrode layer.

### DISCLOSURE

### Technical Problem

An object of the present invention is to provide an electrode for a fuel cell having excellent ion conductivity, improved reaction surface area and increased durability resulted from improved contact between an electrolyte membrane and an electrode layer.

### Technical Solution

To solve the above-mentioned problems, the present invention provides an electrode for a fuel cell that is interposed between an electrolyte membrane and a separator having a fluid channel and comprises a catalyst layer contacted with the electrolyte membrane and a gas diffusion layer contacted with the separator, wherein the catalyst layer includes a catalyst portion containing a plurality of first catalyst particles dispersed in an ionomer binder resin; and an ionomer portion containing a plurality of second catalyst particles dispersed in an ionomer binder resin and having a lower concentration of catalyst particles than the catalyst portion, and wherein the ionomer portion has a shape of a wall or plural pillars in the catalyst portion. The electrode for a fuel cell according to the present invention includes separately the ionomer portion in the catalyst layer to improve ion conductivity and considerably increase a reaction surface area, thereby improving the performance of the fuel cell.

Each of the first catalyst particles and the second catalyst particles of the present invention may be metal catalyst particles or metal catalyst particles on a carbon-based support used typically in the art, and a concentration of the second catalyst particles in the ionomer portion may be zero.

Preferably, height of the ionomer portion pillar of the present invention may be 0.5 to 1 time as large as thickness of the catalyst layer, however the present invention is not limited in this regard.

And, the present invention provides a method of preparing an electrode for a fuel cell, the electrode comprising a catalyst layer that includes a catalyst portion containing a plurality of first catalyst particles dispersed in an ionomer binder resin; and an ionomer portion containing a plurality of second catalyst particles dispersed in an ionomer binder resin and having a lower concentration of catalyst particles than the catalyst portion, the method including (S1) preparing a catalyst portion forming ink and an ionomer portion forming ink having a lower concentration of catalyst particles than the catalyst portion forming ink; (S2) spraying the prepared first catalyst portion forming inkdrops and first ionomer portion forming inkdrops onto preset locations of an electrolyte membrane or a gas diffusion layer in an ink jet method to form a layer; and (S3) stacking second catalyst portion forming inkdrops and second ionomer portion forming inkdrops onto the locations where the first catalyst portion forming inkdrops and the first ionomer portion forming inkdrops were sprayed to form a catalyst portion and an ionomer portion, respectively, and spraying repeatedly each of the second catalyst portion forming inkdrops and the second ionomer portion forming inkdrops in an ink jet method to form a catalyst layer such that the ionomer portion has a shape of a wall or plural pillars in the catalyst portion.

Each of the catalyst portion forming ink and the ionomer portion forming ink may include a metal catalyst or a metal catalyst on a carbon-based support; a polymer ionomer; and a solvent, and the ionomer portion forming ink has a lower concentration of catalyst than the catalyst portion forming ink. If necessary, a concentration of catalyst in the ionomer portion forming ink according to the present invention may be zero.

In the method of preparing an electrode for a fuel cell according to the present invention, spray of inkdrops may be performed while heating according to necessity.

The above-mentioned electrode of the present invention may be used in a membrane electrode assembly and a fuel cell.

### DESCRIPTION OF DRAWINGS

FIG. 1 is a schematic view illustrating the principle for generating electricity of a fuel cell.

FIG. 2 is a view illustrating schematically a general configuration of a membrane electrode assembly for a fuel cell.

FIG. 3 is a view illustrating schematically spray of a catalyst portion forming ink and an ionomer portion forming ink according to the present invention.

FIG. 4 is a plane view illustrating schematically that a catalyst portion forming ink and an ionomer portion forming ink are sprayed onto an electrolyte membrane or a gas diffusion layer to form a plurality of ionomer pillars in a catalyst portion according to the present invention.

FIG. 5 is a plane view illustrating schematically that a catalyst portion forming ink and an ionomer portion forming ink are sprayed onto an electrolyte membrane or a gas diffusion layer to form a wall in a catalyst portion according to the present invention.

FIG. 6 is a cross-sectional view illustrating schematically that a catalyst portion forming ink and an ionomer portion forming ink are sprayed onto an electrolyte membrane or a gas diffusion layer to form a catalyst portion and an ionomer portion.

FIG. 7 is a view illustrating schematically a fuel cell according to an embodiment of the present invention.

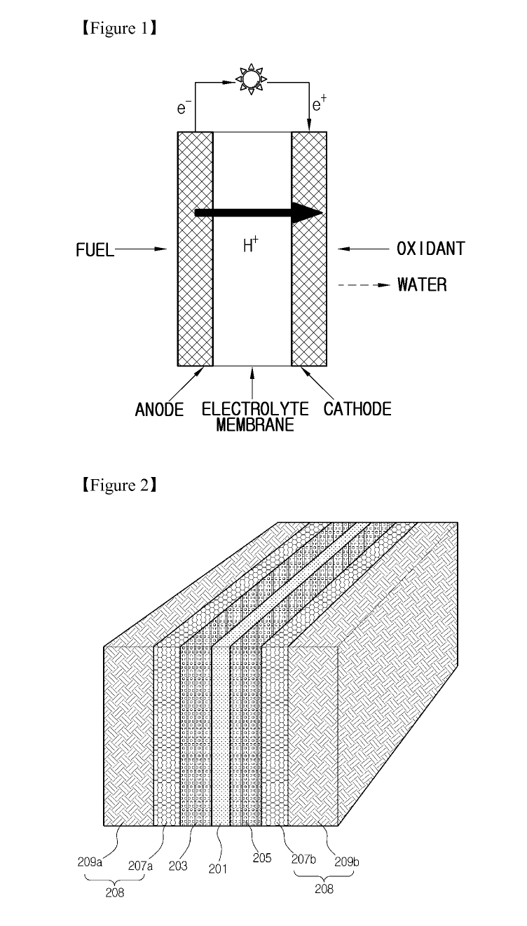

### MODE FOR INVENTION

Hereinafter, an electrode for a fuel cell of the present invention will be described in detail according to its preparing method. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

First, a catalyst portion forming ink and an ionomer portion forming ink having a lower concentration of catalyst particles than the catalyst portion forming ink are prepared (S1).

The catalyst portion forming ink according to the present invention may be a catalyst portion forming ink used in the art. For example, the catalyst portion forming ink may include a metal catalyst or a metal catalyst on a carbon-based support as first catalyst particles; a polymer ionomer; and a solvent. Here, to avoid confusion with the first catalyst particles, catalyst particles included in an ionomer portion to be described below are referred to as second catalyst particles.

Typically, the metal catalyst may be at least one selected from the group consisting of platinum, ruthenium, osmium, platinum-ruthenium alloy, platinum-osmium alloy, platinum-palladium alloy and platinum-transition metal alloy, however the present invention is not limited in this regard.

The carbon-based support may be a carbon-based material, preferably at least one selected from the group consisting of graphite, carbon black, acetylene black, denka black, ketjen black, activated carbon, mesoporous carbon, carbon nanotube, carbon nano fiber, carbon nano horn, carbon nano ring, carbon nano wire, fullerene (C60) and SuperP.

Typically, the polymer ionomer may be a nafion ionomer or a sulfonated polymer such as sulfonated polytrifluorostyrene.

Preferably, the solvent may be at least on selected from the group consisting of water, butanol, isopropanol, methanol, ethanol, n-propanol, n-butylene acetate and ethylene glycol.

The ionomer portion forming ink according to the present invention may be prepared in the same way as the catalyst portion forming ink except a lower concentration of catalyst particles. For example, the ionomer portion forming ink includes a metal catalyst or a metal catalyst on a carbon-based support as second catalyst particles; a polymer ionomer; and a solvent, and has a lower concentration of catalyst particles than the catalyst portion forming ink. And, the ionomer portion forming ink may not include a metal catalyst or a metal catalyst on a carbon-based support according to necessity, so that the concentration of catalyst particles may be zero.

After the above-mentioned inks are prepared, first catalyst portion forming inkdrops and first ionomer portion forming inkdrops are sprayed onto preset locations of an electrolyte membrane or a gas diffusion layer to form a layer (S2).

After the first catalyst portion forming inkdrops and the first ionomer portion forming inkdrops are sprayed, catalyst portion forming inkdrops and ionomer portion forming inkdrops are sprayed onto the locations where the first catalyst portion forming inkdrops and the first ionomer portion forming inkdrops are sprayed. To avoid confusion with the first catalyst portion forming inkdrops and the first ionomer portion forming inkdrops, the subsequently sprayed catalyst portion forming inkdrops and ionomer portion forming inkdrops are referred to as second catalyst portion forming inkdrops and second ionomer portion forming inkdrops, respectively.

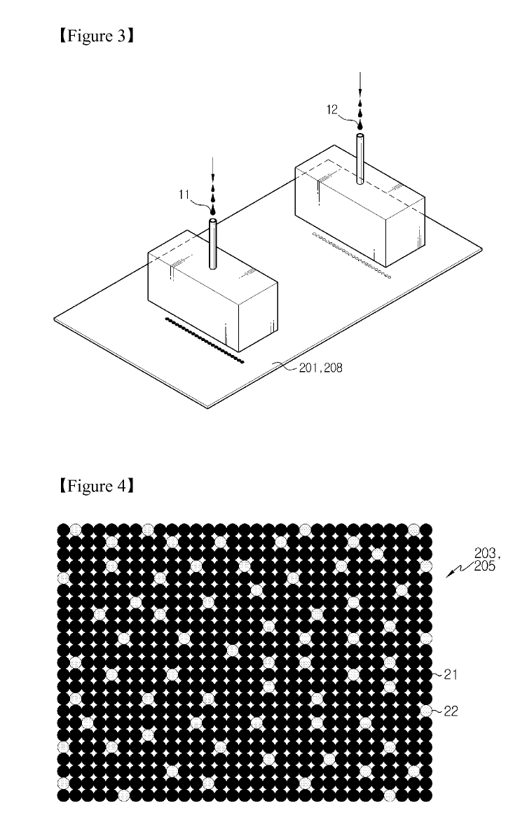

As shown in FIG. 3, a catalyst portion forming ink 11 and an ionomer portion forming ink 12 are sprayed onto an electrolyte membrane 201 or a gas diffusion layer 208. An ink jet method uses the related software to adjust a spray location of inkdrops very precisely, and thus can spray individual inkdrops of the catalyst portion forming ink 11 and the ionomer portion forming ink 12 onto preset locations of the electrolyte membrane 201 or the gas diffusion layer 208.

After the first catalyst portion forming inkdrops and the first ionomer portion forming inkdrops are sprayed onto preset locations of the electrolyte membrane or the gas diffusion layer, as shown in FIGS. 4 an 5, a layer including a catalyst portion 21 and an ionomer portion 22 that are made of the first catalyst portion forming inkdrops and the first ionomer portion forming inkdrops, respectively, is formed on the electrolyte membrane or the gas diffusion layer.

In this case, a location where ionomer portion forming inkdrops are initially sprayed onto the electrolyte membrane or the gas diffusion layer becomes a location of an ionomer wall or pillar to be formed. Therefore, ordinary persons skilled in the art can determine appropriately spray locations of the catalyst portion forming inkdrops and the ionomer portion forming inkdrops according to necessity. For example, as shown in FIG. 4, spray locations of the ionomer portion forming inkdrops may be scattered on the electrolyte membrane or the gas diffusion layer.

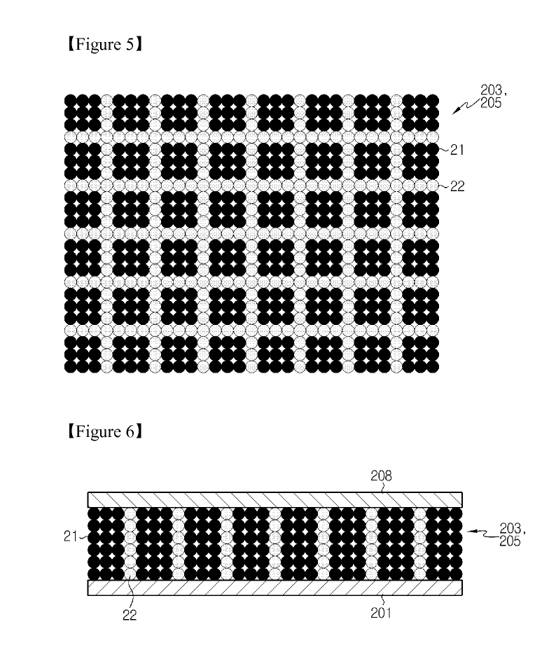

In alternative embodiments, spray locations of the ionomer portion forming inkdrops may be set to form an ionomer wall in a grid pattern, and in this case, the catalyst portion forming inkdrops are located between grids. The ionomer wall of a grid pattern is shown in FIG. 5.

In alternative embodiments, spray locations of the catalyst portion forming inkdrops and the ionomer portion forming inkdrops may be set to form a catalyst portion opposite a fluid channel along the fluid channel or to form an ionomer wall opposite a fluid channel along the fluid channel.

Next, second catalyst portion forming inkdrops and second ionomer portion forming inkdrops are stacked at the locations where the first catalyst portion forming inkdrops and the first ionomer portion forming inkdrops were sprayed, to form a catalyst portion and an ionomer portion, respectively. The second catalyst portion forming inkdrops and the second ionomer portion forming inkdrops are sprayed repeatedly in an ink jet method to form a catalyst layer such that the ionomer portion has a shape of a wall or plural pillars in the catalyst portion (S3).

As mentioned above, the ink jet method can adjust a spray location of inkdrops, and thus catalyst portion forming inkdrops and ionomer portion forming inkdrops can be sprayed onto locations where catalyst portion forming inkdrops and ionomer portion forming inkdrops were sprayed in the previous step. According to the spray method, catalyst portion forming inkdrops can be sprayed repeatedly onto a location where catalyst portion forming inkdrops were sprayed in the previous step, and ionomer portion forming inkdrops can be sprayed repeatedly onto a location where ionomer portion forming inkdrops were sprayed in the previous step. As a result, after inks for forming an electrode are sprayed, catalyst layers 203 and 205 of a preset thickness can be formed, in which an ionomer wall or ionomer pillars 22 are formed in a catalyst portion 21, as shown in FIG. 6.

In the electrode for a fuel cell according to the present invention, an ionomer wall or plural ionomer pillars separately exist in a catalyst layer of an electrode to improve ion conductivity in the electrode and considerably increase a reaction surface area between a catalyst, an ionomer and reaction gas, thereby improving the performance of a fuel cell, which can be sufficiently anticipated by ordinary persons skilled in the art without an additional experiment. And, it is expected that an electrode for a fuel cell including an ionomer wall or plural ionomer pillars according to the present invention can improve contact with an electrolyte membrane or a gas diffusion layer.

The height of the ionomer wall or pillar formed according to the present invention can be controlled appropriately according to necessity, for example the height may be 0.5 to 1 time as large as the thickness of the catalyst layer, however the present invention is not limited in this regard. For example, in the case that the height of the ionomer wall or pillar is smaller than the thickness of the catalyst layer, when an ink is sprayed onto an electrolyte membrane, ionomer portion forming inkdrops may be sprayed onto a certain spot until the ionomer wall or pillar has a required height, and then catalyst portion forming inkdrops may be sprayed onto the same spot that the ionomer portion forming inkdrops were sprayed until the catalyst layer has a preset thickness. Alternatively, in the case that the height of the ionomer wall or pillar is smaller than the thickness of the catalyst layer, when an ink is sprayed onto a gas diffusion layer, catalyst portion forming inkdrops may be sprayed onto a certain spot and then ionomer portion forming inkdrops may be sprayed onto the same spot that the catalyst portion forming inkdrops were sprayed until the ionomer wall or pillar has a required height. Thereby a catalyst layer of a preset thickness can be formed.

And, in the case that inkdrops are sprayed by an ink jet method according to the present invention, the inkdrops may be sprayed while heating to promote drying of the sprayed inkdrops.

The above-mentioned catalyst layer for a fuel cell according to the present invention are formed on an electrolyte membrane or a gas diffusion layer, and may be used to manufacture a membrane electrode assembly for a fuel cell.

As shown in FIG. 2, a membrane electrode assembly for a fuel cell according to the present invention includes an electrolyte membrane 201; and an anode electrode and a cathode electrode located at opposite sides of the electrolyte membrane 201. The anode and cathode electrodes each may include a gas diffusion layer 208 and catalyst layers 203 and 205. The gas diffusion layer 208 for a fuel cell according to the present invention may include substrates 209a and 209b and microporous layers 207a and 207b formed on one side of the substrates 209a and 209b, respectively.

The electrolyte membrane may be an electrolyte membrane used in the art, for example any one polymer selected from the group consisting of perfluorosulfonic acid polymer, hydrocarbon-based polymer, polyimide, polyvinylidene fluoride, polyethersulfone, polyphenylene sulfide, polyphenylene oxide, polyphosphazene, polyethylene naphthalate, polyester, doped polybenzimidazol, polyether ketone, polysulfone, and their acids and bases, however the present invention is not limited in this regard.

The gas diffusion layer may be a gas diffusion layer used in the art, and typically may include a conductive substrate made of any one selected from the group consisting of carbon paper, carbon cloth and carbon felt. The gas diffusion layer may further include a microporous layer formed on one side of the conductive substrate, and the microporous layer may be made of a carbon-based material and a fluorine-based resin.

The carbon-based material of the present invention may be at least one selected from the group consisting of graphite, carbon black, acetylene black, denka black, ketjen black, activated carbon, mesoporous carbon, carbon nanotube, carbon nano fiber, carbon nano horn, carbon nano ring, carbon nano wire, fullerene (C60) and SuperP, however the present invention is not limited in this regard.

The fluorine-based resin may be at least one selected from the group consisting of polytetrafluoroethylene, polyvinylidene fluoride (PVdF), polyvinyl alcohol, cellulose acetate, polyvinylidene fluoride-hexafluoropropylene copolymer (PVdF-HFP) and styrene-butadiene rubber (SBR), however the present invention is not limited in this regard.

At this time, the catalyst layer is formed on the microporous layer of the gas diffusion layer.

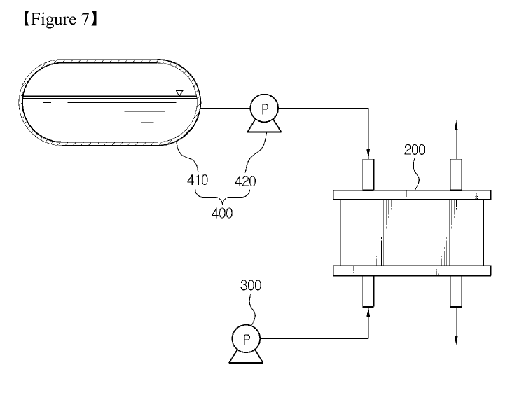

The present invention also provides a fuel cell including the membrane electrode assembly of the present invention. FIG. 7 is a view illustrating schematically a fuel cell according to an embodiment of the present invention. Referring to FIG. 7, the fuel cell of the present invention includes a stack 200, a fuel providing unit 400 and an oxidant providing unit 300.

The stack 200 includes at least one membrane electrode assembly of the present invention, and in the case that at least two membrane electrode assemblies are included, the stack 200 includes a separator interposed between the membrane electrode assemblies. The separator prevents the membrane electrode assemblies from being electrically connected to each other, and transfers a fuel and an oxidant provided from the external to the membrane electrode assemblies.

The fuel providing unit 400 provides a fuel to the stack 200, and may include a fuel tank 410 for storing a fuel and a pump 420 for providing the fuel stored in the fuel tank 410 to the stack 200. The fuel may be gaseous or liquid hydrogen or hydrocarbon fuel, and the hydrocarbon fuel may be, for example methanol, ethanol, propanol, butanol or natural gas.

The oxidant providing unit 300 provides an oxidant to the stack 200. The oxidant is typically oxygen, and the oxidant providing unit 300 may be a pump for injecting oxygen or air.

### INDUSTRIAL APPLICABILITY

The electrode for a fuel cell according to the present invention has excellent ion conductivity in an electrode layer and the remarkably improved reaction surface area to improve the performance of the fuel cell. And, contact between an electrolyte membrane and the electrode layer is improved to enhance durability.

1. An electrode for a fuel cell which is interposed between an electrolyte membrane and a separator having a fluid channel, the electrode comprising:
a catalyst layer contacted with the electrolyte membrane; and
a gas diffusion layer contacted with the separator,
wherein the catalyst layer includes a catalyst portion containing a plurality of first catalyst particles dispersed in an ionomer binder resin; and an ionomer portion containing a plurality of second catalyst particles dispersed in an ionomer binder resin and having a lower concentration of catalyst particles than the catalyst portion, and
wherein the ionomer portion has a shape of a wall or plural pillars in the catalyst portion.

2. The electrode for a fuel cell composition according to claim 1,
wherein each of the first catalyst particles and the second catalyst particles are metal catalyst particles or metal catalyst particles on a carbon-based support.

3. The electrode for a fuel cell according to claim 1,
wherein a concentration of the second catalyst particles in the ionomer portion is zero.

4. The electrode for a fuel cell according to claim 1,
wherein height of the ionomer portion wall or pillar is 0.5 to 1 time as large as thickness of the catalyst layer.

5. The electrode for a fuel cell according to claim 1,
wherein the ionomer portion wall is formed in a grid pattern, and the catalyst portion is formed between grids.

6. The electrode for a fuel cell according to claim 1,
wherein the catalyst portion is formed opposite the fluid channel along the fluid channel, or the ionomer portion wall is formed opposite the fluid channel along the fluid channel.

7. A method of preparing an electrode for a fuel cell, the electrode comprising a catalyst layer that includes a catalyst portion containing a plurality of first catalyst particles dispersed in an ionomer binder resin; and an ionomer portion containing a plurality of second catalyst particles dispersed in an ionomer binder resin and having a lower concentration of catalyst particles than the catalyst portion, the method comprising:
(S1) preparing a catalyst portion forming ink and an ionomer portion forming ink having a lower concentration of catalyst particles than the catalyst portion forming ink;
(S2) spraying the prepared first catalyst portion forming inkdrops and first ionomer portion forming inkdrops onto preset locations of an electrolyte membrane or a gas diffusion layer in an ink jet manner to form a layer; and
(S3) stacking second catalyst portion forming inkdrops and second ionomer portion forming inkdrops onto the locations where the first catalyst portion forming inkdrops and the first ionomer portion forming inkdrops were sprayed to form a catalyst portion and an ionomer portion, respectively, and spraying repeatedly each of the second catalyst portion forming inkdrops and the second ionomer portion forming inkdrops in an ink jet manner to form a catalyst layer such that the ionomer portion has a shape of a wall or plural pillars in the catalyst portion.

8. The method of preparing an electrode for a fuel cell according to claim 7,
wherein the catalyst portion forming ink includes a metal catalyst or a metal catalyst on a carbon-based support; a polymer ionomer; and a solvent.

9. The method of preparing an electrode for a fuel cell according to claim 7,
wherein the ionomer portion forming ink includes a metal catalyst or a metal catalyst on a carbon-based support; a polymer ionomer; and a solvent, and has a lower concentration of catalyst than the catalyst portion forming ink.

10. The method of preparing an electrode for a fuel cell according to claim 9,
wherein a concentration of catalyst in the ionomer portion forming ink is zero.

11. The method of preparing an electrode for a fuel cell according to claim 7,
wherein height of the ionomer portion wall or pillar is 0.5 to 1 time as large as thickness of the catalyst layer.

12. The method of preparing an electrode for a fuel cell according to claim 7,
wherein the ionomer portion wall is formed in a grid pattern, and the catalyst portion is formed between grids.

13. The method of preparing an electrode for a fuel cell according to claim 7,
wherein the catalyst portion is formed opposite a fluid channel along the fluid channel, or the wall of the ionomer portion is formed opposite a fluid channel along the fluid channel.

14. The method of preparing an electrode for a fuel cell according to claim 7,
wherein the inkdrops are sprayed while heating.

15. The method of preparing an electrode for a fuel cell according to claim 7,
wherein the electrolyte membrane is any one polymer selected from the group consisting of perfluorosulfonic acid polymer, hydrocarbon-based polymer, polyimide, polyvinylidene fluoride, polyethersulfone, polyphenylene sulfide, polyphenylene oxide, polyphosphazene, polyethylene naphthalate, polyester, doped polybenzimidazol, polyether ketone, polysulfone, and their acids and bases.

16. The method of preparing an electrode for a fuel cell according to claim 7,
wherein the gas diffusion layer includes a conductive substrate selected from the group consisting of carbon paper, carbon cloth and carbon felt, a carbon-based material and a fluorine-based resin.

17. A membrane electrode assembly for a fuel cell, comprising:
an electrolyte membrane; and
an anode electrode and a cathode electrode formed at opposite sides of the electrolyte membrane, each including a catalyst layer and a gas diffusion layer,
wherein either the anode electrode or the cathode electrode, or both of the electrodes is the electrode for a fuel cell defined in claim 1.

18. A fuel cell, comprising:
a stack including at least one membrane electrode assembly defined in claim 17 and a separator interposed between the membrane electrode assemblies;
a fuel providing unit for providing a fuel to the stack; and
an oxidant providing unit for providing an oxidant to the stack.
